(19) United States
(12) Patent Application Publication
(10) Pub. No.: US 2020/0140712 A1
(43) Pub. Date: May 7, 2020

(54) POLYMERISABLE COMPOSITION COMPRISING TEMPO COMPOUND

(71) Applicant: Lucite International UK Limited, Billingham (GB)

(72) Inventors: Robin Riyadh Gibson, Wilton, Redcar (GB); Neil Tindale, Wilton, Redcar (GB); Philip Andrew Stenson, Wilton, Redcar (GB)

(21) Appl. No.: 16/623,965

(22) PCT Filed: Jun. 18, 2018
(86) PCT No.: PCT/GB2018/051687

§ 371 Date: Dec. 18, 2019

(30) Foreign Application Priority Data
Jun. 19, 2017 (GB) 1709764.3

(51) Int. Cl. C09D 15/00; C08F 20/14; B27K 3/15

(52) U.S. Cl. CPC C09D 15/00; B27K 3/15; C08F 20/14

(57) ABSTRACT

A polymerisable composition suitable for impregnating a permeable material, a process for the treatment of a permeable material, especially wood and an impregnated material is described. The composition includes at least 60% w/w composition of one or more polymerisable monomer(s) and an initiator effective to bulk polymerise the polymerisable monomers above 50° C. The composition includes up to 0.5% w/w tempo compound effective to stabilise the composition at temperatures less than 50° C. or below its thermally activated polymerisation temperature and to not substantially prevent polymerisation above the polymerisation temperature. The process has steps of locating the permeable material in a chamber; evacuating the chamber; adding a thermally initiatable bulk polymerisable composition to the chamber; allowing the material to become impregnated with polymerisable composition; removing excess polymerisable composition; and effecting bulk polymerisation of the composition by increasing the temperature of the impregnated material in the chamber to initiate polymerisation of the composition.

The present invention relates to a polymerisable composition suitable for impregnating a permeable material, a process for the treatment of a permeable material using the polymerisable composition, especially wood. The invention extends to the polymerisation of the composition in such impregnated materials to give composite products, and more particularly to a method for impregnating permeable materials, particularly articles, with such a composition.

GB500223 describes the impregnation of porous materials, e.g. wood, cement, marble, tile, fibre board, cork to a depth below the surface with an impregnant comprising one or more monomeric polymerizable acrylic compounds and a chemical polymerization initiator, after which the impregnant is polymerized in-situ through a free-radical mechanism to give a composite article. Such composite articles may exhibit an improvement in properties such as flexural strength, compressive strength, dimensional stability, scratch resistance and surface hardness over their component parts

Chemical initiators typically comprise azo or peroxy compounds or a mixture thereof and the initiator must be in intimate contact with the monomers in the polymerizable composition to effect free radical polymerisation. The most frequent method of introduction of initiator is by dispersion or dissolution of the initiator in the polymerisable composition, prior to introduction of impregnation composition to the permeable material. Polymerisation is typically induced by increasing the temperature of the impregnated material which causes the chemical initiators to decompose to give free radicals that in turn induce free-radical polymerisation. It is known to be economically impractical to introduce and then remove initiators from intimate mixtures or solutions of monomer and initiator.

GB1188751A discloses that a liquid mixture comprising methyl methacrylate monomer and peroxide free radical initiator, lauryl peroxide, can be used to impregnate a sample of wood by first placing a sample of wood in an impregnating bath, at sub-atmospheric pressure. Once the impregnation stage is complete, a film forming composition is applied to prevent loss of monomer during the thermally induced polymerisation process

One drawback of such impregnation treatments is that industrial scale preparation of composite articles by impregnation necessitates an excess of polymerisable composition to be present during impregnation so that only a portion is incorporated into the void volume of the permeable material on each treatment cycle creating an excess or unused portion. Such unused portion can be wasteful both economically and environmentally. One object of the present invention is to address this problem.

A further drawback of such prior art treatments based on free radical polymerization, and especially thermally initiated free radical polymerisation, is that a chemical initiator must be present in the monomer composition as previously described and, therefore, remains present in the excess or unused monomer composition. The presence of the active, chemical initiator presents both economic and safety problems. Storage of monomer composition which contains chemical initiator is problematic as it can cause the monomer to polymerise during storage thereby not only preventing it being used in subsequent impregnations but also necessitating complex and expensive clean up of equipment. In addition, the process of uncontrolled exothermic polymerisation in stored monomer compositions can pose a safety risk.

Therefore, it would be beneficial if monomer/initiator compositions generated during monomer impregnation processes can be safely stored for reuse.

Inhibitor compounds, also called stabilisers, that effectively prevent free radical polymerization reactions are known and widely used at low concentrations, often in ppm ranges, to provide short term inhibition for storage and transport of monomers. Inhibitor use at such low levels does not necessarily compromise subsequent polymerisation where initiators are added. Such inhibitors are generally used to stabilise the bulk storage of monomers at ambient temperature encountered on transport and storage where there exists the risk of accidental thermal initiation or otherwise of free radical autopolymerization in the absence of an added, chemical initiator. Autopolymerisation can be accelerated at elevated temperatures and as a result, for example, stabilised methyl methacrylate is typically stored and transported below 40° C. Such stabiliser concentration in monomer is carefully controlled to give short term stability at ambient temperatures while not inhibiting intentional polymerisation induced by deliberate addition of initiators as found in many commercial polymerisation processes. Examples of inhibitor or stabiliser compounds include benzene-1,4-diol, 2,4-dimethyl-6-tertbutylphenol, 4-methoxy phenol, phenothiazine, butylated hydroxytoluene and its derivatives, nitrobenzene and 2,2-diphenyl-1-picrylhydrazyl. Such inhibitors need to be intimately present with the monomers they inhibit. Total removal of such inhibitors from a monomer solution is economically impractical. For the avoidance of doubt, such stabilisers are not effective to inhibit deliberate polymerisation caused by chemical initiators but only autopolymerisation.

U.S. Pat. No. 7,009,011 relates to a polymerisation of maleic anhydride with a polymerizable electron donor monomer and initiator in an exothermic reaction and use of stable free radical agents added during the reaction to control the exotherm and keep the temperature within 100-160° C. The amount of stable free radical agent is relatively high as the reaction is particularly exothermic. The agent is used to control the rate of reaction at high temperatures at around 130° C. or above. An object of the invention is to provide a method for impregnating permeable materials with a polymerisable composition, whereby the process may be continuous, semi-continuous or part of a batch treatment cycle as a result of safe and controlled storage of unused monomer/initiator mixtures during the process allowing continuous running of the process by reuse of monomer/initiator mixtures.

According to a first aspect of the present invention there is provided a polymerisable composition suitable for impregnating a permeable material comprising at least 60% w/w composition of one or more polymerisable monomer(s), preferably vinyl monomers, more preferably, acrylic monomers and an initiator effective to bulk polymerise the polymerisable monomers above 50° C., wherein the polymerisable composition comprises up to 0.5% w/w tempo compound effective to stabilise the monomer composition at temperatures less than 50° C. According to a second aspect of the present invention there is provided a process for the treatment of a permeable material, especially wood, comprising the steps of:

locating the permeable material in a chamber;
evacuating the chamber to provide a vacuum effective to treat the permeable material, typically under pressure of less than 1 bar, in the said chamber;
adding a thermally initiatable bulk polymerisable composition to the chamber;
allowing the permeable material to become impregnated with the said polymerisable composition;
removing excess polymerisable composition;
effecting bulk polymerisation of the composition by increasing the temperature of the impregnated material in the chamber to initiate polymerisation of the composition;
wherein the said polymerisable composition comprises at least 60% w/w composition of one or more polymerisable monomer(s), preferably vinyl monomers, and an initiator effective to bulk polymerise the polymerisable monomers above 50° C., wherein the polymerisable composition also comprises up to 0.5% w/w tempo compound effective to stabilise the monomer composition at temperatures less than 50° C.

By having a high monomer content in the polymerisable composition the said permeable material is more easily impregnated by the polymerisable composition.

When the polymerisable composition is added to the chamber there may be an optional increase in pressure to increase impregnation.

Typically, the bulk polymerisation is effected by heating the impregnated material to at least 50° C. to typically thermally initiate and polymerise the polymerisable composition by bulk polymerisation, more typically, by heating to 50-100° C. such as 70-100° C., more typically, 70-80° C. or 50-80° C. Typically the excess polymerisable composition is stored at less than 50° C., more typically at less than 40° C. before re-use and the composition is stable at such temperatures.

Accordingly, by using a thermally labile tempo compound, excess polymerisable composition remains stable at storage temperatures but does not hinder polymerisation after impregnation of the permeable material and thermal initiation.

According to a third aspect of the present invention there is provided a plant for treatment of a permeable material, especially wood, comprising a treatment vessel for treatment of the permeable material by impregnation with a polymerisable composition;

a monomer storage tank comprising the said polymerisable composition; wherein the polymerisable composition comprises at least 60% w/w composition of one or more polymerisable monomer(s), preferably vinyl monomers, and an initiator effective to polymerise the polymerisable monomers, wherein the polymerisable composition comprises up to 0.5% w/w tempo compound effective to stabilise the monomer composition at temperatures less than 50° C.

Typically, the plant includes a pressure evacuator effective to lower the pressure in the treatment vessel to below 1 bar such as 0.9, 0.8, 0.7, 0.5, 0.2 bar or less. Typically, the treatment vessel is therefore a vacuum pressure vessel able to withstand such vacuum pressure. Typically, the plant includes a delivery conduit to deliver the polymerisable composition to the treatment vessel. Typically, the plant includes a drain conduit to facilitate removal of excess polymerisable composition.

According to a fourth aspect the invention extends to an impregnated material comprising a polymerisable composition according to the first aspect or comprising a composition according to the first aspect that has been bulk polymerised, typically, fully bulk polymerised in the said material.

According to a fifth aspect there is provided use of a tempo compound as a temperature dependent stabilizer effective to stabilise a monomer composition containing initiator below its thermally activated polymerisation temperature and to not substantially prevent polymerisation thereof above the said polymerisation temperature.

Preferably, the polymerisable composition comprises at least 60% w/w such as at least 70% w/w composition of one or more polymerisable monomer(s), more typically, at least 80% w/w, most typically, at least 90% w/w, especially at least 95% w/w composition, preferably such monomers are vinyl monomers, more preferably, acrylic monomers, especially one or more of those listed herein, more especially, methyl methacrylate.

Preferably the permeable material is wood, this may be a hard wood or a soft wood, more preferably a soft wood species selected without limitation from the genera Abies, Larix, Picea, Pinus, Pseudotsuga, Sequoia, Taxus and Tsuga, Without limitation, hardwood species may include angiosperms such as Fraxinus, Populus, Ochroma, Betula, Prunus, Ulmus, Eucalyptus, Carya, Swietenia, Acer, Quercus, Juglans, Salix, Bambusoideae and Cocos.

By stabilise the monomer composition is meant to prevent polymerisation thereof to an appreciable extent for at least 12 hours, more preferably, for at least 24 hours, most preferably, for at least 48 hours. By appreciable extent is meant less than 10% polymerisation of total monomer present, more preferably, less than 5% polymerisation of total monomer present, most preferably, less than 2% polymerisation of total monomer present.

By permeable is meant permeable to the liquid phase polymerisable composition. This encompasses materials permeable to the said polymerisable composition under above atmospheric pressure.

By “tempo compound” is meant a stable nitroxide free radical, and includes a natural or synthetically substituted variant, functional analog or derivative of tempo which retains or contains the temperature dependent inhibitory effect of tempo.

The tempo compound is typically according to formula Ia

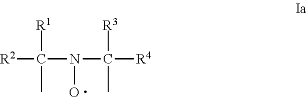

wherein R¹, R², R³ and R⁴ are hydrogen or alkyl groups and hydrogen is not bound to the remaining valencies on the carbon atoms bound to nitrogen.

The alkyl groups R¹, R², R³ and R⁴ may be the same or different, and preferably contain 1 to 15 carbon atoms. It is particularly preferred to use nitroxides in which R¹, R², R³ and R⁴ are independently methyl, ethyl or propyl groups.

The remaining valencies of the carbon atoms which are not R¹, R², R³ and R⁴ or nitrogen may be satisfied by any atom or group except hydrogen which can bond covalently to carbon although some groups may reduce the stabilizing power of the nitroxide structure. Examples of suitable atoms or groups are halogen, cyanide, —C(O)OR wherein R is alkyl or aryl, —C(O)NH₂, —SPh, —S—COCH₃, —OCOCH₃, —OCOC₂H₅, alkenyl where the double bond is not in conjugation with the group —N—, and alkyl. The two remaining valencies which are not satisfied by R¹ to R⁴, or nitrogen may also form part of a ring.

Where the remaining valencies of formula Ia are satisfied by alkyl groups, R⁷, R⁸, it gives a compound of formula Ib

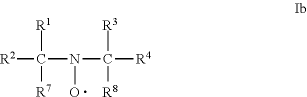

wherein the groups R⁷ to R⁸ preferably contain 1 to 15 carbon atoms. Examples of suitable groups R⁷ and R⁸ are methyl, ethyl and propyl groups. A specific example of a suitable compound having the structure Ib is di-t-butyl nitroxide.

In a particularly advantageous embodiment of the present invention the nitroxide has between 8 and 9 carbon atoms in the molecule. Nitroxides with this number of carbon atoms in the molecule are particularly effective in suppressing polymerization.

Examples of suitable compounds of formula Ia in which the remaining valencies of the carbons to which —N— is attached form part of a ring are pyrrolidine-1-oxyls and piperidine-1-oxyls. A particular example of a suitable compound in which the remaining valencies of formula Ia form part of a ring is 2,2,6,6-tetramethyl-4-hydroxy-piperidine-1-oxyl. Accordingly, the compound may be according to formula Ic

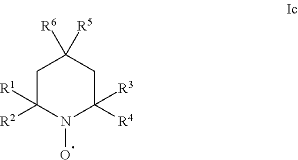

wherein R⁵ and R⁶ may be selected from hydrogen, C₁ to C₆ alkyl, acetamido, amino, 2 haloacetamido, carboxy, hydroxy, benzoate, isothiocyanate, maleimido, alkoxy, oxo, phosphonooxy, methacrylyloxy, methylsulfonyloxy, silyloxy, ethoxyfluorophosphonyloxy and 4-nitrobenzoyloxy;
or R⁵ may be an oligomer to which the rest of the compound is bound at the 4-position and R⁶ is hydrogen;
R¹ to R⁴ may be selected from hydrogen or C₁ to C₁₂ alkyl, preferably hydrogen or C₁ to C₂ alkyl, most typically, hydrogen or methyl;
or R1 and/or R3 and/or R6 may form a further ring or rings such that the tempo compound has a bicyclic or tricyclic structure such as an adamantane structure.

The term halo herein means a halogen but is preferably bromo or iodo

The term alkoxy means a C₁ to C₆ alkoxy group, typically, methoxy, ethoxy or propoxy or may be an ethylene or propylene glycol residue or oligomer thereof and more than one tempo molecular moiety may be attached if there are multiple alkoxy bonds thereof.

The term aryl means C₅ to C₂₀ aryl, more preferably, C₅ to C₁₀ aryl such as phenyl or benzyl.

Generally, R⁶ is hydrogen or C₁ to C₆ alkyl and R⁵ is selected from hydrogen, acetamido, amino, 2-haloacetamido, carboxy, hydroxy, benzoate, isothiocyanate, maleimido, alkoxy, oxo, phosphonooxy, methacrylyloxy, methylsulfonyloxy, silyloxy, ethoxyfluorophosphonyloxy and 4-nitrobenzoyloxyl.

Typical n-oxoammonium salts are exemplified by the compound (2,2,6,6-Tetramethylpiperidin-1-yl)oxyl (CAS 2564-83-2), otherwise known as TEMPO, and its related derivatives such as 4-hydroxyTEMPO and 4-acetamidoTEMPO.

It will be appreciated that the nitroxide free radical is the active tempo compound and that the tempo compound need not be added to the composition as a free radical and can be produced in situ from a suitable precursor or salt thereof.

Advantageously, the composition permits the storage at ambient temperatures of a polymerizable composition of monomer and chemical initiator while not inhibiting and therefore permitting full polymerisation at elevated temperatures so allowing economical reuse of initiator containing monomer compositions in impregnation processes.

Therefore, the tempo compounds have been found to act as a highly effective temperature switch when employed at controlled levels in a mixture of monomer and initiator in the present invention.

The polymerisable composition may be introduced into the permeable materials under varying pressure and/or temperatures to achieve impregnation of the of the permeable materials to the extent required, for example the polymerisable composition may occupy up to 100% of the internal void volume in the permeable materials or even in excess of the void volume. Once the required level of impregnation is achieved, the polymerizable composition is polymerised in-situ using an appropriate method which may comprise chemical initiation, to effect the desired degree of polymerisation within the solid to create the composite article.

Other additives may be included in the polymerisable composition for example, chemical species to modify the process or product, such as solvent, plasticiser, wetting agents, accelerating agents, dispersed or dissolved polymers, chain transfer agents, cross linkers and mixtures thereof. Such additives may aid impregnation and/or add functionality to the final composite product such as colour, UV stability, antimicrobial effects, flame retardancy etc. These additives may also be introduced to the permeable material apart from the polymerisable composition but are generally included therein.

Impregnation of the permeable material in the present invention may employ continuous, semi-batch or batch processes.

The polymerisable monomers of the present invention preferably contain unsaturated carbon-carbon bonds that are sufficiently reactive to sustain polymerisation by free radical initiated propagation.

Examples of such monomers include those containing carbon-carbon double or triple bonds. Examples of monomers containing such groups in the present invention may be selected from ethylene, styrene, acrylic monomers and combinations thereof. It is preferable that such carbon-carbon double or triple bonds ethylene are bonded to and conjugated with an immediately adjacent unsaturated carbon-carbon or carbon-heteroatom bond where the carbon or heteroatom are electron withdrawing. Examples of this type of monomer are propenal and the various acrylic monomers. In the present invention acrylic monomers are preferred.

The term acrylic monomers herein refers to monomers having a polymerisable acrylic group and includes (alk)acrylic acid and esters thereof. Preferred acrylic monomers include one or more (C₀₋₈alk)acrylic acids and C₁₋₁₈ esters thereof or mixtures thereof.

Suitable acrylic monomers may be selected from the type (Y)acrylic acid or X(Y)acrylate esters thereof where both X and Y may independently be linear or branched and may be independently selected from alkyl, cycloalkyl, alkenyl, alkynyl or aryl groups which may contain heteroatoms. Examples include acrylic acid, methacrylic acid, methyl acrylate, methyl methacrylate, ethyl acrylate, ethyl methacrylate, ethyl acrylate, n-butyl acrylate, iso-butyl acrylate, t-butyl acrylate, n-butyl methacrylate, iso-butyl methacrylate, t-butyl methacrylate, 2-ethylhexyl acrylate, 2-ethylhexyl methacrylate, lauryl methacrylate, lauryl acrylate, allyl acrylate, allyl methacrylate, stearyl methacrylate, stearyl acrylate, tridecyl methacrylate, tridecyl acrylate, cyclohexyl acrylate, cyclohexyl methacrylate, isobornyl acrylate, isobornyl methacrylate, benzyl methacrylate, benzyl acrylate, phenyl methacrylate and phenyl acrylate

Examples of acrylic monomers containing heteroatoms may include 2-hydroxyethyl acrylate, 2-hydroxyethyl methacrylate, 2-hydroxypropyl acrylate, 2-hydroxypropyl methacrylate, methoxyethyl acrylate, methoxyethyl methacrylate, 2-ethoxyethyl acrylate, 2-ethoxyethyl methacrylate, 2,2,2-trifluoroethyl acrylate, 2,2,2-trifluoroethyl methacrylate, glycidyl acrylate, glycidyl methacrylate, dimethylaminoethyl acrylate, dimethylaminoethyl methacrylate.

Further examples of acrylic monomers containing heteroatoms of the acrylic type include acrolein, acrylonitrile, 2-methacryloyloxyethyl phthalic acid and 2-methacryloyloxyethyl hexahydrophthalic acid.

Examples of acrylic monomers containing a plurality of acrylic groups include 1,3-butyleneglycol diacrylate, 1,3-butyleneglycol dimethacrylate, 1,6-hexandiol diacrylate, 1,6-hexandiol dimethacrylate, trimethylolpropane triacrylate, trimethylolpropane trimethacrylate, acrylic anhydride, methacrylic anhydride and other assymetric anhydrides comprising dissimilar acrylic groups such as acrylic methacrylic anhydride.

Examples of heterocyclic monomers containing the acrylate group include the family of alpha methylene lactones.

Suitable vinyl monomers other than acrylic monomers are vinyl compounds such as ethylene, styrene, vinyl pyrrolidinone and vinyl pyridine. Typically, methyl methacrylate is used in the present invention. It will be appreciated that the term “vinyl monomers” herein should be construed to include alkacrylates and alkacrylic acids as well as acrylates and acrylic acid i.e. the vinyl group should be construed as CH₂═CR— wherein R is not only hydrogen but also an alkyl, cycloalkyl, alkenyl, alkynyl or aryl group which may contain heteroatoms. The polymerisable monomers of the present invention and as claimed herein may include but optionally do not include maleic anhydride or derivative thereof.

Where there is more than one monomer there is generally up to four, more typically, three, most typically, two monomers. In such cases, the monomers may be present in any ratio but generally, one monomer forms the major part such as at least 70% w/w of the total monomers present, more typically, at least 80% of the total monomers present, especially, at least 90% of the total monomers present. Preferred monomers which form the only monomer or the major monomer part as indicated may be selected from methyl methacrylate, ethyl methacrylate, methyl acrylate, ethyl acrylate, methacrylic acid, acrylic acid, n-butyl acrylate, iso-butyl acrylate, t-butyl acrylate, n-butyl methacrylate, iso-butyl methacrylate, t-butyl methacrylate, 2-ethyl hexyl methacrylate, 2-ethyl hexyl acrylate, styrene, vinyl pyrrolidinone and vinyl pyridine, more preferably, from methyl methacrylate, methyl acrylate, methacrylic acid, acrylic acid, n-butyl acrylate, n-butyl methacrylate, styrene, vinyl pyrrolidinone and vinyl pyridine, most preferably, from methyl methacrylate, methacrylic acid, acrylic acid, and styrene, especially methyl methacrylate.

The initiators of the present invention are typically thermally activated initiators. Typically, the initiators of the present invention are chemical initiators, more typically, chemical initiators that decompose above a thermal activation temperature to form free radicals capable of effecting free radical polymerisation of the monomers. Typically, the thermal activation temperature is above 50° C. Initiators used in the present invention can comprise any of the known free radical initiators suitable for bulk polymerisation which includes halogen compounds which may use transition metal co-catalysts, azo compounds of which azobisisobutyronitrile (AIBN (CAS 78-67-1)) and 4,4′-azobis(4-cyanovaleric acid are examples, organic peroxide compounds (e.g., benzoyl peroxide (CAS 94-36-0), tert-butylhydroperoxide, tert-amylhydroperoxide, di-(2-ethylhexylperoxyd icarbonate or lauroyl peroxide) and inorganic peroxides of which peroxydisulphate salts and persulphates, (e.g., potassium, sodium or ammonium) and hydrogen peroxide, are examples.

Accordingly, preferred initiators in the present invention are thermally activated free radical initiators, more typically, those whose 10 hour half life temperature is greater than 40° C., preferably greater than 45° C., more preferably greater than 50° C. and most preferably greater than 60° C. or above to effect free radical initiation of the monomers in the polymerisable composition. The term half life and 10 hour half life is known to the skilled person but half life may be taken as the time required to reduce the original initiator content of a composition by 50%, at a given temperature so that 10 hour half life temperature is the temperature at which the initiator content of a composition is reduced by 50% in 10 hours.

The initiator is present at a level effective to bulk polymerise the polymerisable composition at or above the thermal initiation temperature. Typically, the initiator is present at up to 2% w/w composition, more typically, up to 1.5% w/w composition, most typically, up to 1% w/w composition.

Typically, the initiator component is present in an amount effective to fully polymerize the polymerisable monomers. For example, to at least polymerize 85% w/w of the monomers, more typically, at least 90% w/w, most typically, 95%-98% w/w of the monomers. In addition, the initiator component may be present in excess of the amount that would be effective to fully polymerize the monomers.

Typically, the monomer content is between 60-99.9% w/w composition, more typically, between 60 and 99.7% w/w composition, most typically between 70 and 99.5% w/w composition, preferably such monomers are vinyl monomers, more preferably, acrylic monomers, especially one or more of those listed herein, more especially, methyl methacrylate.

As stated above, the tempo compound is present in the polymerisable composition at up to 0.5% w/w composition. Typically, the tempo compound is present in the composition in the range 0.001% w/w to 0.5% w/w, more typically, 0.005 to 0.2% w/w, most typically, 0.01 to 0.1% w/w. Therefore, the tempo compound may typically be present in the polymerisable composition at up to 0.3% w/w, such as up to 0.075% w/w. Typically, there is at least 0.005% w/w tempo compound present in the polymerisable composition, such as at least 0.01% w/w. Therefore, the tempo compound may be present in the range 0.001% w/w to 0.1% w/w or 0.075% w/w composition.

Typically, the mol:mol ratio of tempo:initiator compound is in the range 1:1000 to 1:1, more typically, in the range 1:100 to 1:1, most typically, 1:100 to 1:2, especially, 1:100 to 1:5, more especially, 1:100 to 1:10. Accordingly, the tempo compound may be between 0.1 and 100 mol % of initiator, more preferably, 0.5 to 100 mol % initiator, most preferably, 1 to 50 mol % initiator, especially, between 0.1 and 20 mol % initiator, more especially 0.5 to 10 mol % initiator, most especially, 1 to 5 mol % initiator. Therefore, the mol:mol ratio of tempo:initiator may be in the range 1:1000 to 1:5. Additionally, the tempo compound may be between 0.1 to 10 or 5 mol % initiator.

Therefore the tempo compound is typically present at 0.001 to 1 mol % composition, more typically, 0.003 to 0.5 mol % composition, most typically, 0.005 to 0.2 mol % composition. Alternatively, 0.001 to 0.1 mol % or 0.075 mol % composition.

Polymerisation of the polymerisable composition of the present invention is typically but not exclusively a first or pseudo first order reaction with rate dependent on two critical factors, concentration of the initiator and reaction temperature as exemplified by the rate equation In([A]/[A]₀)=−kt.

The tempo compound used in the bulk polymerisation reaction is generally all present in the composition at the start of the bulk polymerisation reaction, in any case, at least 80% mol/mol of the total tempo compound used in the bulk polymerisation reaction is present in the polymerisable composition at the commencement of the bulk polymerisation reaction, more typically, at least 90% mol/mol, most typically, about 100% mol/mol mol of the total tempo compound used in the bulk polymerisation reaction is present in the polymerisable composition at the commencement of the bulk polymerisation reaction.

### EXAMPLES

### Comparative Example 1

To exemplify this invention, we selected softwood as the Porous Material to be impregnation. Sections of scots pine (Pinus sylvestris) (150×21×21 mm) were dried at 60° C. for 16 hours in an unpressurised laboratory oven, weighed and loaded into an autoclave fitted with vacuum and a high pressure N₂ supply. The pressure of the autoclave was reduced below ambient pressure using vacuum and maintained for 30 minutes. A 0.1% w/w solution of 1,1′-azobis(2-methylpropionitrile) (Vazo 64; available from Arkema) in methyl methacrylate (Methyl Methacrylate 25TA; available from Lucite International and stabilised with 25 ppm 2,4-Dimethyl-6-tert-butylphenol commercially available as Topanol A from multiple commercial sources) was prepared and introduced to the vessel under vacuum such that the wood sections were submerged. The vacuum was maintained for a further 30 mins. The pressure in the vessel was then increased to 5 bar for 30 mins. Subsequently, the pressure was reduced to ambient levels and the vessel was drained. The impregnated pine sections were then wrapped in aluminium foil and transferred to an oven and heated to 75° C. for 16 hours. The weights of cured samples were recorded and PMMA levels (% w/w) calculated.

### Example 1

The same process described in Comparative Example 1 was carried out with the addition of 260 ppm 4-hydroxy-2,2,6,6-tetramethylpiperidine-1-oxyl (4-Hydroxy-TEMPO; available from Sigma Aldrich) to the methyl methacrylate solution. The weights of cured samples were recorded and PMMA levels (% w/w) calculated. Levels of PMMA in the resulting cured composites from Comparative Example 1 and Example 1 are shown in Table 1

TABLE 1

| | Monomer mix composition | | |
|---|---|---|---|
| | Vazo 64 | | Composite |
| Sample | % w/w | 4-Hydroxy-TEMPO/ppm | % PMMA w/w |
| I (Comparative | 0.1 | 0 | 33.96 |
| Example 1) | | | |
| II (Example 1) | 0.1 | 260 | 29.97 |

### Comparative Example 2

A 0.2% w/w solution of 1,1′-azobis(2-methylpropionitrile) (Vazo 64; available from Arkema) in methyl methacrylate (Methyl Methacrylate 25TA; available from Lucite International containing 25 ppm Topanol A) was prepared. The solution was heated to 37° C. and maintained at that temperature. Small samples (˜0.5 g) of the solution were taken periodically and allowed to evaporate from a shallow dish at ambient temperature such that the % solids content could be determined to calculate degree of polymerisation. Complete gelation of the sample was observed after 7 days and was accompanied by exothermic autoacceleration which is consistent with the Trommsdorff effect indicating complete polymerisation.

### Example 2

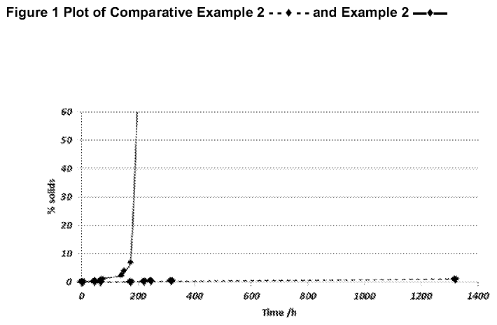

The same process described in Comparative Example 2 was carried out with the addition of 520 ppm 4-hydroxy-2,2,6,6-tetramethylpiperidine-1-oxyl to the monomer solution. Small samples (˜0.5 g) of the solution were taken periodically and allowed to evaporate from a shallow dish at ambient temperature such that the % solids content could be determined to calculate degree of polymerisation. The monomer solution was observed to remain fluid up to 55 days at 37° C. with no rise in the % solids above 1%. No Trommsdorff effect was observed. The data showing % Solids against time for Comparative Example 2 and Example 2 are shown in FIG. 1.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A polymerisable composition suitable for impregnating a permeable material comprising at least 60% w/w composition of one or more polymerisable monomer(s), and an initiator effective to bulk polymerise the polymerisable monomers above 50° C., wherein the polymerisable composition comprises up to 0.5% w/w tempo compound effective to stabilise the monomer composition at temperatures less than 50° C.

2. A process for treatment of a permeable material comprising the steps of:
locating the permeable material in a chamber;
evacuating the chamber to provide a vacuum effective to treat the permeable material in the said chamber;
adding a thermally initiatable bulk polymerisable composition to the chamber;
allowing the permeable material to become impregnated with the said polymerisable composition;
removing excess polymerisable composition;
effecting bulk polymerisation of the composition by increasing the temperature of the impregnated material in the chamber to initiate polymerisation of the composition;
wherein the said polymerisable composition comprises at least 60% w/w composition of one or more polymerisable monomer(s) and an initiator effective to bulk polymerise the polymerisable monomers above 50° C., wherein the polymerisable composition also comprises up to 0.5% w/w tempo compound effective to stabilise the monomer composition at temperatures less than 50° C.

3. The process according to claim 2, wherein the bulk polymerisation is effected by heating the impregnated material between 50-100° C. to thermally initiate and polymerise the polymerisable composition by bulk polymerisation.

4. The process according to claim 2, wherein at least 80% mol/mol of the total tempo compound used in the bulk polymerisation reaction is present in the polymerisable composition at the commencement of the bulk polymerisation reaction.

5. The process according to claim 2, wherein excess polymerisable composition is stored at less than 50° C. before re-use and the excess polymerisable composition is stable at such temperatures.

6. A treatment plant for treatment of a permeable material, comprising a treatment vessel for treatment of the permeable material by impregnation with a polymerisable composition;
a monomer storage tank comprising the said polymerisable composition; wherein the polymerisable composition comprises at least 60% w/w composition of one or more polymerisable monomer(s), and an initiator effective to polymerise the polymerisable monomers, wherein the polymerisable composition comprises up to 0.5% w/w tempo compound effective to stabilise the monomer composition at temperatures less than 50° C.

7. The plant according to claim 6, including a pressure evacuator effective to lower pressure in the treatment vessel to below 1 bar.

8. The polymerisable composition according to claim 1, wherein the composition comprises at least 60% w/w of one or more polymerisable monomer(s), wherein the polymerisable monomers are vinyl monomers.

9. The polymerisable composition according to claim 1, wherein the permeable material is wood.

10. The polymerisable composition according to claim 1, wherein the tempo compound is formula Ia 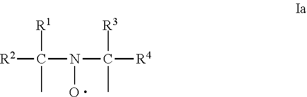
wherein R¹, R², R³ and R⁴ are hydrogen or alkyl groups and hydrogen is not bound to the remaining valencies on the carbon atoms bound to nitrogen.

11. The polymerisable composition according to claim 10, wherein the alkyl groups R¹, R², R³ and R⁴ are the same or different.

12. The polymerisable composition of claim 10, wherein the remaining valencies of the carbon atoms in the tempo compound which are not R¹, R², R³ and R⁴ or nitrogen are any atom or group except hydrogen which can bond covalently to carbon.

13. The polymerisable composition of claim 12, wherein the compound is according to formula Ic 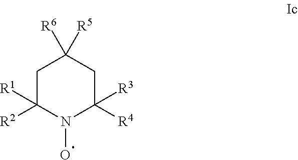
wherein R⁵ and R⁶ are selected from hydrogen, C₁ to C₆ alkyl, acetamido, amino, 2-haloacetamido, carboxy, hydroxy, benzoate, isothiocyanate, maleimido, alkoxy, oxo, phosphonooxy, methacrylyloxy, methylsulfonyloxy, silyloxy, ethoxyfluorophosphonyloxy and 4-nitrobenzoyloxy;
or R⁵ is an oligomer to which the rest of the compound is bound at the 4-position and R⁶ is hydrogen;
R¹ to R⁴ are selected from hydrogen or C₁ to C₁₂ alkyl;
or R1 and/or R3 and/or R6 form a further ring or rings such that the tempo compound has a bicyclic or tricyclic structure;
wherein halo means a halogen;
wherein the term alkoxy means a C₁ to C₆ alkoxy group, and more than one tempo molecular moiety may be attached if there are multiple alkoxy bonds thereof;
wherein the term aryl means C₅ to C₂₀ aryl.

14. The polymerisable composition of claim 13, wherein R⁶ is hydrogen or C₁ to C₆ alkyl and R⁵ is selected from hydrogen, acetamido, amino, 2-haloacetamido, carboxy, hydroxy, benzoate, isothiocyanate, maleimido, alkoxy, oxo, phosphonooxy, methacrylyloxy, methylsulfonyloxy, silyloxy, ethoxyfluorophosphonyloxy and 4-nitrobenzoyloxyl.

15. The polymerisable composition of claim 1, wherein the tempo compound is selected from 2,2,6,6-Tetramethylpiperidin-1-yl)oxyl (CAS 2564-83-2), 4-hydroxyTEMPO and 4-acetamidoTEMPO.

16. The polymerisable composition of claim 1, wherein the one or more polymerisable monomer(s), are vinyl monomers selected from ethylene, styrene, acrylic monomers and combinations thereof.

17. The polymerisable composition according to claim 16, wherein the vinyl monomers are acrylic monomers selected from (alk)acrylic acids and esters thereof or mixtures thereof.

18. The polymerisable composition according to claim 17, wherein the acrylic monomers or mixtures thereof are selected from the type (Y)acrylic acids and X(Y)acrylate esters thereof where both X and Y may independently be linear or branched and are independently selected from alkyl, cycloalkyl, alkenyl, alkynyl or aryl groups which may contain heteroatoms.

19. The polymerisable composition according to claim 16, wherein the vinyl monomers other than acrylic monomers are selected from ethylene, styrene, vinyl pyrrolidinone and vinyl pyridine.

20. The polymerisable composition of claim 1, wherein the initiator is a thermally activated initiator.

21. The polymerisable composition of claim 1, wherein the initiators are thermally activated free radical initiators.

22. The polymerisable composition of claim 1, wherein the Initiators are free radical initiators selected from halogen compounds which may use transition metal co-catalysts, azo compounds organic peroxide compounds or inorganic peroxides.

23. The polymerisable composition of claim 1, wherein the initiator is present at up to 2% w/w composition.

24. The polymerisable composition of claim 1, wherein the monomer content is between 60-99.9% w/w composition.

25. The polymerisable composition of claim 1, wherein the tempo compound is present in the polymerisable composition.

26. The polymerisable composition of claim 1, wherein the tempo compound is present in the polymerisable composition at up to 0.3% w/w.

27. The polymerisable composition of claim 1, wherein there is at least 0.003% w/w tempo compound present in the polymerisable composition.

28. The polymerisable composition of claim 1, wherein a mol:mol ratio of tempo:initiator compound ranges from 1:1000 to 1:1.

29. The polymerisable composition of claim 1, wherein the tempo compound may be between 0.1 and 100 mol % of initiator.

30. The polymerisable composition of claim 1, wherein the tempo compound is present at 0.001 to 1 mol % composition.

31. An impregnated material comprising a polymerisable composition according to claim 1 that has been bulk polymerised.

32. (canceled)

33. The process of claim 2, wherein the permeable material is wood.
